(19) United States
(12) Patent Application Publication
(10) Pub. No.: US 2014/0096971 A1
(43) Pub. Date: Apr. 10, 2014

(54) NEW METHOD AND ARRANGEMENT FOR FEEDING CHEMICALS INTO A HYDROFRACTURING PROCESS AND OIL AND GAS APPLICATIONS

(71) Applicants: Timothy S. Keizer, Aurora, IL (US); Tommy Jacobson, Helsinki, FL (US)

(72) Inventors: Timothy S. Keizer, Aurora, IL (US); Tommy Jacobson, Helsinki, FL (US)

(21) Appl. No.: 13/645,671

(22) Filed: Oct. 5, 2012

(51) Int. Cl. E21B 43/00; C09K 8/62; E21B 43/26

(52) U.S. Cl. CPC E21B 43/00; E21B 43/26; C09K 8/62
USPC 166/308.2; 166/310; 166/308.1

(57) ABSTRACT

A method of rapidly and essentially simultaneously creating and feeding a dispersion into a hydrocarbon process stream. This method allows for the effective use of chemical additives in a hydrocarbon process line that are highly unstable or that are very difficult to disperse. This is especially helpful in hydrofracturing operations as the very rapid flow rates require very fast dispersion formations. As a result the method allows greater fracking pressures which can be obtained with lower energy inputs and by using lessor amounts of chemical additives. As a result hydrocarbon extraction can be accomplished in a manner which is both more environmentally friendly as well as less expensive.

### CROSS-REFERENCE TO RELATED APPLICATIONS

This application is a continuation-in-part of co-pending U.S. patent application Ser. No. 12/474,990 filed on May 29, 2009 which itself was a continuation-in-part of U.S. patent application Ser. No. 11/339,169 filed on Jan. 25, 2006 which has issued as U.S. Pat. No. 7,550,060.

### STATEMENT REGARDING FEDERALLY SPONSORED RESEARCH OR DEVELOPMENT

Not Applicable.

### BACKGROUND OF THE INVENTION

This invention relates generally to a method and apparatus for feeding chemicals into a process stream of an oil or gas application and in particular to a hydrofracturing process.

As described for example in US Published Patent Applications 2011/0180263, 2011/0180422, 2012/0118579, 2012/0152816, 2010/00163230, 2008/0128125, 2008/0176770, Hydrocarbon extraction (e.g., oil and natural gas) in a hydrocarbon-bearing zone of a subterranean formation can be reached by drilling a wellbore into the earth, either on land or under the sea that penetrates into the hydrocarbon-bearing formation. Such a wellbore can be used to extract hydrocarbons or as an injector well to inject a fluid, e.g., water or gas, to drive the relevant fluids/gasses into a production wellbore. Typically, such a wellbore must be drilled thousands of feet into the earth to reach the hydrocarbon-bearing formations. Usually, but not always, the greater the depth of the well, the higher the natural “static” temperature of the formation.

After drilling an openhole, the next step is referred to as “completing” the wellbore. A wellbore is sometimes completed openhole, that is, without cemented casing in place adjacent to the producing formations. More typically, however, as part of the well completion process, a metal pipe, known as “casing” is positioned and cemented into place in the openhole.

The main purpose of cementing the casing is to stabilize the wellbore against collapse and to prevent undesirable migration of fluids along the wellbore between various zones of subterranean formations penetrated by the wellbore. Where the wellbore penetrates into a hydrocarbon-bearing zone of a subterranean formation, the casing can be perforated to allow fluid communication between the zone and the wellbore. A zone of a wellbore that penetrates a hydrocarbon-bearing zone that is capable of releasing hydrocarbons is referred to as a “production zone.” The casing also enables subsequent or remedial separation or isolation of one or more production zones of the wellbore, for example, by using downhole tools such as packers or plugs, or by using other techniques, such as forming sand plugs or placing cement in the perforations.

Whether the wellbore is openhole or cased, various procedures are often employed to complete the wellbore in preparation for production of hydrocarbons. For example, one common procedure is gravel packing to help prevent sand and fines from flowing with the hydrocarbon produced into the wellbore. This particulate material can be damaging to pumps and other oilfield equipment and operations.

Another example of a common procedure to stimulate the flow of hydrocarbon extraction production from the hydrocarbon-bearing zones is hydraulic fracturing of a formation. Hydraulic fracturing or “hydrofracturing” involves injecting fluid down a well bore at high pressure. The fracturing fluid is typically a mixture of water and proppant (the term “proppant” includes sand and synthetics). Other chemicals are often added to the proppant to aid in proppant transport, friction reduction, wettability, pH control and bacterial control.

Varying amounts of water are required in a typical hydraulic fracturing operation. Water is usually trucked to the well head site from other locations, typically in large quantities. The water may come from a variety of sources that include untreated water from rivers, lakes, or water wells. Once delivered to the well head site, the water is mixed with the proppant particulates and then pumped down the well bore.

During the fracturing process, the fracturing fluid penetrates producing formations (sometimes called “subterranean formations”) at sufficient hydraulic pressure to create (or enhance) underground cracks or fractures—with the proppant particulates supporting the fracture for “flow back.” Sometimes the process is repeated a multiple number of times at the well site. When this is done, the well head is closed between stages to maintain water pressure of the fracturing fluid for a period of time.

Fracturing treatments stimulate hydrocarbons extraction by creating more flow paths or pathways for the hydrocarbons to travel up the well bore for retrieval. Matrix treatments are different in that they are intended to restore natural permeability of the underground formation following damage. The make-up of the fracturing fluid is often designed to address different situations of this kind by making adjustments in the material and chemical content of the fluid and proppant particulates.

After a well has been completed and placed into production, from time to time it is helpful to workover a well by performing major maintenance or remedial treatments. Workover includes the stimulation or remediation of a well to help restore, prolong, or enhance the production of hydrocarbons. During well servicing or workover, various treatment procedures may be used, including for example, gravel packing, hydraulic fracturing, and frac-packing as mentioned for well completion.

It is also common, for example, to gravel pack after a fracturing procedure, and such a combined procedure is sometimes referred to as a “frac-packing.”

All of these procedures, from drilling the wellbore, to completion, to workover, employ appropriate fluids. During the initial drilling and construction of the wellbore, the fluids are often referred to as drilling fluids. In other stages, such as well completion, servicing, or workover, the fluids introduced into the wellbore are often referred to as treatment fluids, completion fluids, or workover fluids. A well treatment fluid is used for a wide range of purposes, such as stimulation, isolation, or control of reservoir gas or water or formation particles. As used herein, however, a “treatment fluid” includes any appropriate fluid to be introduced into a wellbore, whether during drilling, completion, servicing, workover, or any other such stage.

More particularly, for example, a treatment performed to enhance or restore the productivity of a well is called a stimulation treatment. Stimulation treatments fall into two main groups, matrix treatments and hydraulic fracturing treatments. Matrix treatments are performed below the reservoir fracture pressure and generally are designed to restore or enhance the natural permeability of the reservoir in the near-wellbore area. Matrix operations can include treating the formation with an acid to dissolve some of the acid soluble rock material. For various reasons known in the art, is sometimes desirable to perform a matrix treatment with a viscosified or gelled fluid.

Fracturing treatments are performed above the fracture pressure of the reservoir formation and create a highly conductive flow path between the reservoir and the wellbore. In general, hydraulic fracturing involves injecting a fracturing fluid through the wellbore and into an oil and gas bearing subterranean formation at a sufficiently high rate of fluid flow and at a sufficiently high pressure to initiate and extend one or more fractures in the formation. To conduct hydraulic pressure through the wellbore, the fracturing fluid must be relatively incompressible under the treating conditions. In addition, because of the large quantities of fracturing fluid required, the fracturing fluid is preferably based on readily-available and plentiful fluid. Thus, the typical fracturing fluid is based on water.

Often properly dosing and introducing the particular chemicals is complicated by the nature of the environments they are subjected to. To be effective the chemicals must be sufficiently dispersed when coming into contact with either specific locations along the well bore and/or specific locations within the subterranean formations. This is further complicated by the fact that some portions of the process flow (such as the well bore) are predominantly aqueous and some (such as the subterranean formations) predominantly organic. This renders many prior art methods of dispersing chemicals which are suitable for only one environment ineffective.

Thus there is a clear need for and utility in an improved methods and apparatuses for dispersing chemicals within an oil or gas process stream and in particular in a hydrofracturing process. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

At least one embodiment of the invention is directed towards a method of feeding a dispersion into a hydrocarbon process line. The method comprises essentially simultaneously manufacturing the dispersion and feeding the dispersion into a process line of a hydrocarbon process line. The dispersion may be manufactured and essentially simultaneously fed to a hydrocarbon process line at a location that is a very close distance to the process pipe. The very close distance may be a distance from 0 cm to about 2 cm. The dispersion may be an emulsion and/or may be a chemical additive to a fracking fluid.

The chemical additive may comprise a friction reducer fed at a speed such that but for the essentially simultaneous manufacturing and feeding, if it had not been pre-inverted, the friction reducer would not have had sufficient time to invert into a polymer in-oil emulsion before passing along casing walls of the hydrocarbon process line. The chemical additive may comprise a peracetic acid made in situ within the hydrocarbon process line and if it had been pre-generated rather than been made in situ, more of the acid would have degraded before contacting microorganisms and thereby been less effective. The chemical additive may be dispersed in the presence of a polymer flocculent selected from the group consisting of: latex polymers and dispersion polymers, an organic coagulant selected from the group consisting of an epichlorohydrin-dimethylamine condensation polymer and a polydiallyl-dimethylammonium chloride polymer, alone or in combination, with an inorganic coagulant, and a precipitant selected from the group consisting of an alkaline sodium aluminate liquor, an acidic magnesium salt in phosphoric acid/magnesium phosphate solution, and combinations thereof.

The chemical additive may be selected from the list consisting of: hydrochloric acid, acetic acid, formic acid, 2,2-Dibromo-3-nitrilopropionamide, polycyclic organic matter, polynuclear aromatic hydrocarbons, gluteraldehyde, diammonium peroxidisulphate, ammonium persulfate, ammonium sulphate, ethylene glycol, glycol ethers, salts, tetramethyl ammonium chloride, potassium chloride, methanol, propargyl alcohol, boric acid, monoethanolamine, polyacylamide sodium acrylate-acylamide copolymer, guar gum, citric acid, thioglycolic acid, diesel, benzene, toluene, ethylbenzene, xylene, naphthalene, sand, ceramic beads, ammonium chloride, polyacrylate, methanol, isopropanol, and any combination thereof.

The method may further comprise the steps of:

a) providing one or more feeding apparatuses, each feeding apparatus comprising:

a first conduit having one or more inlets and outlets;

a second conduit having one or more or more inlets and outlets, wherein the first conduit secures to the second conduit and traverses the second conduit;

a mixing chamber that has one or more inlets and outlets, wherein the second conduit secures to the mixing chamber and wherein the outlets of the first conduit and the outlets of the second conduit are in fluid communication with the mixing chamber; and

an adaptor that is in fluid communication with the outlet of the mixing chamber and is secured to the mixing chamber;

b) mounting at least one feeding apparatus containing an adaptor over an opening in the process pip,
c) introducing the dispersion and one or more chemicals into the mixing chamber of the feeding apparatus by introducing the dispersion or one or more chemicals into the inlets of the first conduit and the second conduit, the dispersion being introduced nearly simultaneous to its;
d) mixing the dispersion and one or more chemicals in the mixing chamber of the feeding apparatus to form a mixture; and
e) dispensing the mixture into the hydrocarbon process stream through the adaptor of the feeding apparatus that is in communication with the process stream.

The dispersion may be introduced to the hydrocarbon process stream at a location along the stream consisting of: the well head, the well bore, the well casing, the production zone, the subterranean formation, and any combination thereof.

### BRIEF DESCRIPTION OF THE DRAWINGS

A detailed description of the invention is hereafter described with specific reference being made to the drawings in which:

FIG. 1 is a side elevation view of an apparatus according to at least one embodiment of the invention.

FIG. 2 is a cross-sectional view of the apparatus of FIG. 1.

FIG. 3 is a side elevation view of at least one embodiment of the invention according to first conduit of the apparatus of FIG. 1.

FIG. 4 is a side elevation view of the adaptor of the apparatus of FIG. 1.

FIG. 5 is an exploded side elevation view of the first conduit, second conduit, mixing chamber and adaptor of at least one embodiment of the invention.

FIG. 6 represents a schematic illustration of a method of feeding chemical into a process stream in accord with at least one embodiment of the invention.

FIG. 7 represents a schematic illustration of an apparatus of at least one embodiment of the invention.

FIG. 8 illustrates a schematic drawing of a use of the invention in a hydrocarbon extraction process.

FIG. 8a illustrates an exploded view of the productive zone of FIG. 8.

FIG. 9 is a side elevation view of an apparatus according to one embodiment of the present invention.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Breaker composition” means a composition of matter capable of inhibiting or deactivating at least one of the characteristics of a chemical additive for which the chemical additive is typically injected into a hydrocarbon process line.

“Chemical Additive” means a composition of matter injected into at least one location of a hydrocarbon process line which has a particular chemical or physical characteristic that enhances the extraction of hydrocarbons.

“Consisting Essentially of” means that the methods and compositions may include additional steps, components, ingredients or the like, but only if the additional steps, components and/or ingredients do not materially alter the basic and novel characteristics of the claimed methods and compositions.

“Disinfectant” means an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

“Dispersion” means a liquid mixture in which a dispersed phase liquid is effectively distributed throughout a continuous phase liquid.

“Distal” is the opposite of “Proximal” and means subsequent to a particular step in a sequential process.

“Emulsion” means a liquid dispersion in which a dispersed phase liquid, which is otherwise immiscible within a continuous phase liquid, is effectively distributed throughout the continuous phase liquid by means of some chemical and/or process.

“Fracking Fluid” means a composition of matter injected into a hydrocarbon process line to facilitate a hydrofracturing process, fracking fluids commonly comprise one or more of acid, biocide, breaker, clay stabilizer, corrosion inhibitor, crosslinker, friction reducer, gelling agent, iron control agent, linear gel carrier fluid, proppant, scale inhibitor, surfactant, and water.

“Free,” “No,” “Substantially no” or “Substantially free” means a composition, mixture, or ingredient that does not contain a particular compound or to which a particular compound or a particular compound-containing compound has not been added. According to the invention, the reduction and/or elimination of hydrogen peroxide according to embodiments provide hydrogen peroxide-free or substantially-free compositions. Should the particular compound be present through contamination and/or use in a minimal amount of a composition, mixture, or ingredients, the amount of the compound shall be less than about 3 wt-%. More preferably, the amount of the compound is less than 2 wt-%, less than 1 wt-%, and most preferably the amount of the compound is less than 0.5 wt-%.

“Hydrocarbon Process Line” means any portion of the process of removing hydrocarbon fluids from an subterranean formation which involves the flow of a fluid, this includes but is not limited to the flow of one or more fluids down a well bore into the subterranean formation as well as the flow of hydrocarbons or other fluids back up the well bore, it also includes the flow of fluids used in a hydrofracturing process, and includes the treatment of waste fluids produced by the hydrocarbon extraction process.

“Microorganism” means any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

“Peroxygen producing chemical” means a composition of matter that contains two or more oxygen atoms in the form of an oxygen-oxygen bond and that induce a higher oxidation state in another composition of matter, peroxygen producing chemical includes but is not limited to: hydrogen peroxide, percarbonate salts, persulfate salts, perborate salts, permanganate salts, carbamide peroxide, and alkyl peroxides such as tert-butyl hydroperoxide and potassium monopersulfate, and any compound of the formula R—(COOOH)ₙ in which R can be hydrogen, alkyl, alkenyl, alkyne, acylic, alicyclic group, aryl, heteroaryl, or heterocyclic group, and n is 1, 2, or 3, and named by prefixing the parent acid with peroxy, as well as those sulfonated carboxylic acid compositions described in as disclosed in US Published Patent Applications 2010/0021557, 2010/0048730 and 2012/0052134.

“Proximal” is the opposite of “Distal” and means prior to a particular step in a sequential process.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

Hydrocarbon extraction and especially hydrofracturing involve the injection of one or more chemicals into one or more portions of: a well bore, well head, well casing, or subterranean formation. These chemicals may address or remedy a number of technical and physical problems that occur and complicate the extraction of hydrocarbons. Often the chemical additives must be added in specific dosages and they must be properly dispersed throughout the fluid medium they are injected into. A number of technical constraints however complicate proper application of these chemicals. In addition a number of specific chemical involve unique properties that pose specific difficulties. Often the best way to address the technical problems is to effectively disperse or emulsify at least one chemical additive while nearly simultaneously injecting it into at least one location along a hydrocarbon process line.

One example of a representative chemical additive is a friction reducer. Friction reducers are injected to reduce friction between the well casing and the fracking fluid. Friction reduces increase the effective pressure fracking fluids can apply to subterranean formations. As a result, decreasing friction leads to lower energy costs for a hydrofracturing process.

Friction reducers are used in water or other water-based fluids used in hydraulic fracturing treatments for subterranean well formations in order to improve permeability of the desired gas and/or oil being recovered from the fluid-conductive cracks or pathways created through the fracking process. The friction reducers allow the water to be pumped into the formations more quickly. Various polymer additives have been widely used as friction reducers to enhance or modify the characteristics of the aqueous fluids used in well drilling, recovery and production applications.

Examples of commonly used friction reducers include polyacrylamide polymers and copolymers. In an aspect, additional suitable friction reducers may include acrylamide-derived polymers and copolymers, such as polyacrylamide (sometime abbreviated as PAM), acrylamide-acrylate (acrylic acid) copolymers, acrylic acid-methacrylamide copolymers, partially hydrolyzed polyacrylamide copolymers (PHPA), partially hydrolyzed polymethacrylamide, acrylamide-methyl-propane sulfonate copolymers (AMPS) and the like. Various derivatives of such polymers and copolymers, e.g., quaternary amine salts, hydrolyzed versions, and the like, should be understood to be included with the polymers and copolymers described herein.

In at least one embodiment the friction reducer (and/or one or more of the additives) comprises one or more of the methods and compositions disclosed in U.S. Pat. Nos. 3,442,803, 3,938,594, 4,225,445, 4,781,845, 5,692,563, 6,787,506, and 7,621,335.

Friction reducers are often combined with water and/or other aqueous fluids, which in combination are often referred to as “slick water” fluids. Slick water fluids have reduced frictional drag and beneficial flow characteristics which enable the pumping of the aqueous fluids into various gas- and/or oil-producing areas, including for example for fracturing.

In at least one embodiment, a friction reducer is present in a use solution in an amount between about 100 ppm to 1000 ppm. In a further aspect, a friction reducer is present in a use solution in an amount of at least about 0.01 wt-% to about 10 wt-%, preferably at least about 0.01 wt-% to about 5 wt-%, preferably at least about 0.01 wt-% to about 1 wt-%, more preferably at least about 0.01 wt-% to about 0.5 wt-%, and still more preferably at least about 0.01 wt-% to about 0.1 wt-%. Beneficially, the compositions and methods of the invention do not negatively interfere with friction reducers included in an aqueous solution.

Friction reducers however are typically stored as polymer in-aqueous continuous phase emulsions and they need to be inverted into a polymer in-organic continuous phase emulsions. Prior art inversion methods typically are slow so they must either be conducted well in advance of the injection requiring complicated storage and make down equipment or must be injected at a slow rate to give the emulsion time to form. Slow injection however is impractical for hydrofracturing as this would inhibit the required high pressure. Commonly fracking fluids flow down a well bore at rates in excess of 4000 gallons/minute. As a result at least one embodiment of the invention is directed towards a method of emulsifying a friction reducer into a polymer in an organic continuous phase emulsion while substantially simultaneously injecting that emulsion into a portion of a hydrocarbon process line.

In at least one embodiment the method so rapidly inverts the chemical additive from an additive in water emulsion to an additive in organic emulsion that a degree of hydrofracturing pressure can be achieved that would otherwise be impossible or would at least damage the equipment or would impose unwanted costs on its use. In at least one embodiment the pressure applied is such that but for the substantially simultaneously inversion and injection, the friction pressure would damage the well bore casings and would cause a leak of fracking fluids proximal to the subterranean formation.

In at least one embodiment the chemical additive is dispersed or emulsified in the presence of at least one of the compositions of matter described in U.S. Pat. No. 5,531,907. In at least one embodiment the chemical additive is dispersed or emulsified in the presence of a polymer flocculent selected from the group consisting of latex polymers and dispersion polymers, an organic coagulant selected from the group consisting of an epichlorohydrin-dimethylamine condensation polymer and a polydiallyl-dimethylammonium chloride polymer, alone or in combination, with an inorganic coagulant, and a precipitant selected from the group consisting of an alkaline sodium aluminate liquor, an acidic magnesium salt in phosphoric acid/magnesium phosphate solution, and mixtures of the foregoing precipitants to form a mixture.

In at least one embodiment the chemical additive is one or more compositions of matter used as or in a fracking fluid. In at least one embodiment the chemical additive is selected from the list consisting of: hydrochloric acid, acetic acid, formic acid, 2,2-Dibromo-3-nitrilopropionamide, polycyclic organic matter, polynuclear aromatic hydrocarbons, gluteraldehyde, diammonium peroxidisulphate, ammonium persulfate, ammonium sulphate, ethylene glycol, glycol ethers, salts, tetramethyl ammonium chloride, potassium chloride, methanol, propargyl alcohol, boric acid, monoethanolamine, polyacylamide sodium acrylate-acylamide copolymer, guar gum, citric acid, thioglycolic acid, diesel, benzene, toluene, ethylbenzene, xylene, naphthalene, sand, ceramic beads, ammonium chloride, polyacrylate, methanol, isopropanol, and any combination thereof.

In at least one embodiment the chemical additive comprises one or more microorganisms. As described in U.S. Pat. No. 6,627,657 and US Patent Application 2010/0163230, the introduction of certain microorganisms into the subterranean formation aids in the recovery of hydrocarbons. In at least one embodiment the microorganism is injected in the company of a sugar and/or other nutrients to facilitate the vitality of the organism. Proper dispersion of nutrients with microorganisms helps the organism establish a foothold in the subterranean formation and increases the likelihood of survival and spread of such microorganisms.

In at least one embodiment the chemical additive comprises one or more items which are highly unstable and if it is not nearly simultaneously dispersed and injected, it will not have as much or any beneficial effect because it will degrade before enough of it can make effective contact with its intended target. An illustrative example of this principle can be seen in the application of certain biocides and disinfectants.

In at least one embodiment the additive comprises a combination of a friction reducer with a peracid composition. Representative peracid compositions (which can be used alone or in combination with a friction reducer, corrosion inhibitor, or any of the other additives mentioned herein) include one or more of the methods and compositions described in US Published Patent Applications 2009/0269324, 2010/0160449, and U.S. Pat. No. 7,156,178. Without being limited to a particular theory of the invention, it is thought that the reduction and/or elimination of the oxidant hydrogen peroxide from the peracid composition promotes the stability and efficacy of any variation in the amount of friction reducer present in a use solution. Highly effective mixing is thought to further enhance this effect. In at least one embodiment the additive and/or method of its introduction comprises one of the methods or compositions disclosed in Provisional U.S. Patent application 61/617814. In at least one embodiment the additive and/or method of its introduction comprises one of the methods or compositions disclosed in the US patent application having an attorney docket number of 3075US01 and a title of “STABLE HIGH RATIO PEROXYCARBOXYLIC ACIDS TO HYDROGEN PEROXIDE COMPOSITIONS WITH SYNERGISTIC BINARY STABILIZERS AND THEIR USE THEREOF”.

Various peracid stabilizers may be included in compositions according to the invention. For example, dipicolinic acid (picolinic acid, 2,6-Pyridinedicarboxylic acid) provides stabilizing for high mineral content peracids. Beneficially, the peracid stabilizer dipicolinic acid prevents the peracid compositions from exceeding their self-accelerating decomposition temperatures (SADT). The use of the peracid stabilizer beneficially stabilizes high acidity peracids, including mixed peracid compositions, constraining the SADT of the compositions providing significant benefits for transportation of the compositions.

Stabilizers may be present in amounts sufficient to provide the intended stabilizing benefits, namely constraining the SADT of peracid compositions, as may vary depending upon the acidity of the peracid composition. Such agents may be present in a use solution in an amount of at least about 0.001 wt-% to about 10 wt-%, preferably at least about 0.001 wt-% to about 10 wt-%, more preferably from about 0.01 wt-% to about 1 wt-%.

In at least one embodiment the chemical additive comprises one or more biocides and or one or more disinfectants. Some microorganisms interfere with hydrocarbon extraction or produce unwanted effects in the recovered hydrocarbons or in the waste streams produced by the extraction process. Some representative examples of biocides or disinfectants are those disclosed in U.S. Pat. Nos. 5,976,386 and 3,254,952 and US Published Patent Application 2009/0311164.

In at least one embodiment, the additive/biocide/disinfectant comprises or is created out of a peroxygen producing chemical and/or a peracetic acid. In at least one embodiment the biocide/disinfectant is generated in situ within the hydrocarbon process line according to at least one of the methods described in U.S. patent application Ser. No. 12/979,806, U.S. Pat. No. 7,012,154 and US Published Application 2006/0025627 A1. The peracetic acid is generated by the reaction within the volume of a peroxygen producing chemical with an activator. In at least one embodiment the peroxygen source is one item selected from the list consisting of hydrogen peroxide, percarbonate salts, persulfate salts, perborate salts, permanganate salts, carbamide peroxide, and alkyl peroxides such as tert-butyl hydroperoxide and potassium monopersulfate.

In at least one embodiment, the activator is an acyl compound. In at least one embodiment the acyl compound is an N-acyl, O-acyl, or S-acyl compound, TAEA, TAED, acetylsalicylic acid, pentaacetylglucose, acetyl imidazole, acetyl CoA, and any combination thereof. The acyl compound functions as an acyl donor which reacts with the peroxygen source to form peracetic acid. In prior art such as U.S. Pat. No. 5,045,222 TAEA is described as useful in laundry applications. In international patent application WO 94/18297 TAED is described as useful in laundry applications.

In at least one embodiment the biocide/disinfectant comprises a peracid. Peracids are highly effective when properly applied but are also unstable and rapidly degrade. As a result in some circumstances unless the peracid is highly dispersed when injected it will degrade before it is able to optimally interact with the undesirable microorganisms. Near simultaneous dispersal and injection of the peracid greatly increases its effectiveness.

In at least one embodiment the chemical additive comprises one or more breaker compositions. A number of additives are added to the fracking fluid to facilitate desired conditions when travelling down the well bore. Once there however they may cause unwanted aftereffects and as a result it is useful that they be eliminated or neutralized after having served their intended purpose. An example of a breaker is an emulsion breaker which breaks up emulsions once within the subterranean formation. Some representative examples of emulsion breakers are the methods and compositions described in U.S. Pat. No. 4,316,806.

Another breaker which can be simultaneously dispersed and injected is a viscosity agent breaker. As described in US Published Patent Application 2008/0176770, viscosity agents are added to fracking fluids to assure that the chemical additives do not fall to the bottom of the well but instead are carried along into the fractures. As a result the viscosity of the fracking fluid is tuned to be viscous enough to retain other additives while not so viscous as to impair the pressure being applied to the fractures. Because of its unique chemical and physical properties, the optimal viscosity for any given well is unique and can vary based on the degree to which hydrocarbons have been removed. Once injected however the viscosity agent makes more difficult the process of removing the hydrocarbons. As a result breakers are added to break up the viscosity agents into non-viscosity increasing materials. In at least one embodiments one or both of viscosity agents and viscosity agent breakers are simultaneously dispersed and injected into the hydrocarbon process line to optimize the effective viscosity at any given moment.

Viscosity enhancers are polymers used in water or other water-based fluids used in hydraulic fracturing treatments to provide viscosity enhancement. Natural and/or synthetic viscosity-increasing polymers may be employed in compositions and methods according to the invention. Viscosity enhancers may also be referred to as gelling agents and examples include guar, xanthan, cellulose derivatives and polyacrylamide and polyacrylate polymers and copolymers, and the like.

In at least one embodiment, a viscosity enhancer is present in a use solution in an amount between about 100 ppm to 1000 ppm. In a further aspect, a viscosity enhancer is present in a use solution in an amount of at least about 0.01 wt-% to about 10 wt-%, preferably at least about 0.01 wt-% to about 5 wt-%, preferably at least about 0.01 wt-% to about 1 wt-%, at least about 0.01 wt-% to about 2 wt-%, preferably at least about 0.01 wt-% to about 1 wt-%, preferably at least about 0.01 wt-% to about 0.5 wt-%. Beneficially, the compositions and methods of the invention do not negatively interfere with viscosity enhancer included in an aqueous solution. Without being limited to a particular theory of the invention, it is believed the reduction and/or elimination of the oxidant hydrogen peroxide from the peracid composition promotes the stability and efficacy of any variation in the amount of viscosity enhancer present in a use solution.

In at least one embodiment the chemical additive comprises one or more corrosion inhibitors. Corrosion inhibitors are additional molecules used in oil and gas recovery operations. Corrosion inhibitors that may be employed in the present disclosure are disclosed in U.S. Pat. No. 5,965,785, U.S. patent application Ser. No. 12/263,904, GB Patent 1,198,734, and International Patent Publications WO/03/006581, WO04/044266, and WO08/005058.

In at least one embodiment, a corrosion inhibitor is present in a use solution in an amount between about 100 ppm to 1000 ppm. In a further aspect, a corrosion inhibitor is present in a use solution in an amount of at least about 0.0001 wt-% to about 10 wt-%, preferably at least about 0.0001 wt-% to about 5 wt-%, preferably at least about 0.0001 wt-% to about 1 wt-%, preferably at least about 0.0001 wt-% to about 0.1 wt-%, and still more preferably at least about 0.0001 wt-% to about 0.05 wt-%. Beneficially, the compositions and methods of the invention do not negatively interfere with corrosion inhibitor included in an aqueous solution. Without being limited to a particular theory of the invention, it is believed the reduction and/or elimination of the oxidant hydrogen peroxide from the peracid composition promotes the stability and efficacy of any variation in the amount of corrosion inhibitor present in a use solution.

In at least one embodiment the chemical additive comprises one or more scale inhibitors. Scale inhibitors are additional molecules used in oil and gas recovery operations. Common scale inhibitors that may be employed in these types of applications include polymers and co-polymers, phosphates, phosphate esters and the like.

In an aspect of the invention, a scale inhibitor is present in a use solution in an amount between about 100 ppm to 1000 ppm. In a further aspect, a scale inhibitor is present in a use solution in an amount of at least about 0.0001 wt-% to about 10 wt-%, at least about 0.0001 wt-% to about 1 wt-%, preferably at least about 0.0001 wt-% to about 0.1 wt-%, preferably at least about 0.0001 wt-% to about 0.05 wt-%. Beneficially, the compositions and methods of the invention do not negatively interfere with scale inhibitor included in an aqueous solution. Without being limited to a particular theory of the invention, it is thought that the reduction and/or elimination of the oxidant hydrogen peroxide from the peracid composition promotes the stability and efficacy of any variation in the amount of scale inhibitor present in a use solution.

In at least one embodiment the near simultaneous dispersion (or emulsification) and injection is accomplished by the use of at least one of the methods or apparatuses described in U.S. Pat. No. 7,550,060.

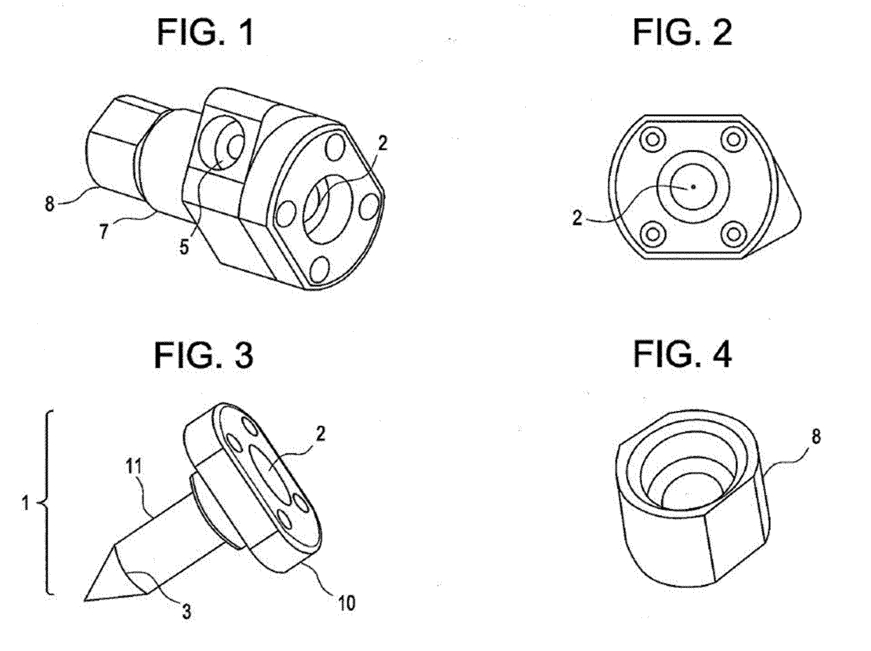

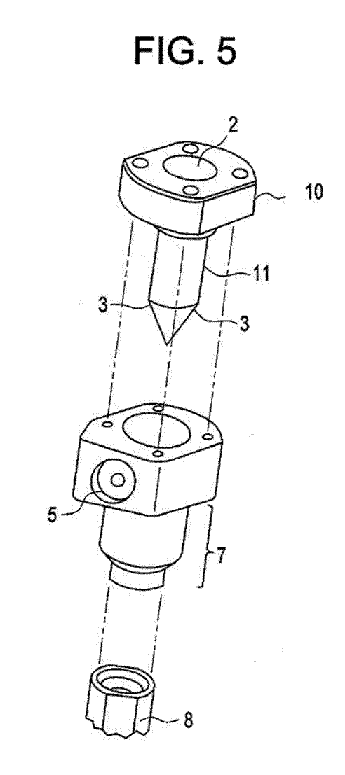

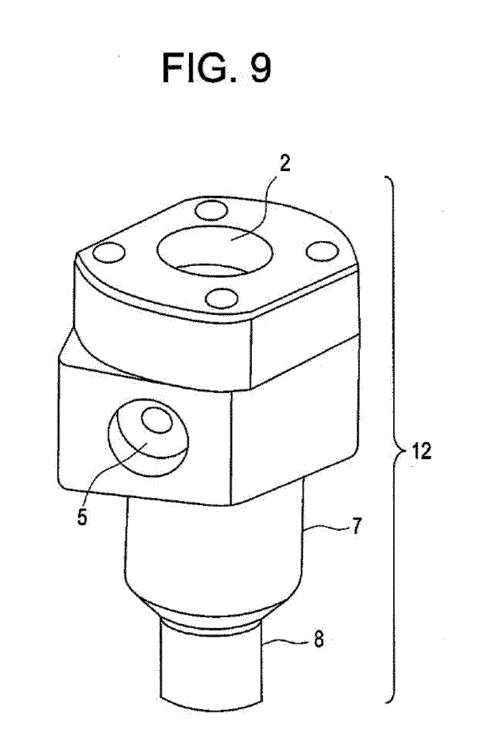

In at least one embodiment the near simultaneous dispersion (or emulsification) and injection is accomplished by the use of at least one of the apparatuses illustrated in FIGS. 1-9. These apparatuses are essentially a reactor where chemical reactions can either: a) happen to activate the chemicals added to the apparatus expeditiously under controlled conditions, or b) the chemicals can be prevented from mixing with each other or other species by selecting appropriate mixing times versus chemical kinetics and shear levels. For example, the reaction rate of the chemicals that are being added to the process stream can be slowed down or even prevented by ensuring much slower chemical kinetics than the residence times inside the device.

As illustrated in FIG. 1, the apparatus includes four primary components: a first conduit (1); a second conduit (4); a mixing chamber (7); and optionally an adaptor (8). The dimensions and geometries of each element of the apparatus depends upon how much chemical needs to be added to the process, as well other factors, such as the construction of the process line (9) it feeds into. The apparatus of the present invention may be made of any suitable material for handling various types of hydrocarbon process chemicals, for example, stainless steel.

The first conduit (1) has one or more inlets (2) and outlets (3). Preferably, the conduit has both a head portion (10) and a portion (11) that is conical in shape.

The second conduit (4) has one or more inlets (5) and outlets (6). The second conduit (4) secures to the first conduit's head portion (10) by any fastening means that would be appreciated by one of ordinary skill in the art, for example, the head portion (10) of the first conduit and the second conduit (4) may have one or more openings so that a screw can secure one conduit to another.

The mixing chamber (7) has one or more inlets (17) and outlets (18) that are in communication with the outlets of both the first conduit (1) and the second conduit (4). The mixing chamber (7) secures to the second conduit (4). The mixing chamber (7) may secure to the second conduit (4) by any fastening means that would be appreciated by one of ordinary skill in the art, for example, both the second conduit (4) and the mixing chamber (7) may have one or more openings so that a screw can secure the second conduit to the mixing chamber, or the outer surface of the mixing chamber (7) can fuse to the outer surface of the second conduit (4).

The adaptor (8) secures to the mixing chamber (7) and is communication with the outlets of the mixing chamber (7). The adaptor (8) may secure to the mixing chamber (7) by any fastening means that would be appreciated by one of ordinary skill in the art, for example, a portion of the mixing chamber (7) may insert into the adaptor (8).

In another embodiment, the inlets (5) of said second conduit (4) are perpendicular to said outlets of said second conduit (4).

In another embodiment, the first conduit (1) traverses said second conduit (4) perpendicular to the inlets (5) of said second conduit (4).

In another embodiment, the first conduit (1) has a head portion (10) that does not traverse said second conduit (4) and a portion that traverses said second conduit (4), wherein the portion (11) that traverses said second conduit (4) is conical in shape and wherein the point of said first conduit (1) is in communication with said mixing chamber (7).

As stated above, the present invention provides for a method of feeding one or more chemicals into a process stream. In one embodiment, the (12) adaptor (8), alone or as part of the apparatuses for feeding, is mounted over an opening (16) in the hydrocarbon process line (9) and the adaptor (8) is secured to the hydrocarbon process line (9) by any means that would be appreciated by one of ordinary skill in the art. The feeding apparatus of the present invention, if not already done so, is connected with the adaptor. Various methods for introducing the chemicals and feeding liquid into the apparatus may be employed, for example, through a pipeline or tubing that are in communication with the apparatus. After this setup is established, one or more chemicals and a feeding liquid are introduced into the apparatus (12), mixed in the mixing chamber (7), and fed into the hydrocarbon process line (9).

In another embodiment, the co-feeding of different chemicals into a process stream (13) can be achieved by the following steps: introducing several different chemicals into the apparatus (12), allowing a mixture of the different chemicals to form, and dispensing the mixture into a process stream (13); or by aligning a series of apparatuses (12) and dispensing chemicals. Chemicals may be added to the system in any order prescribed by a person of ordinary skill in the art. For example, chemicals maybe added sequentially, simultaneously or in pre-programmed order.

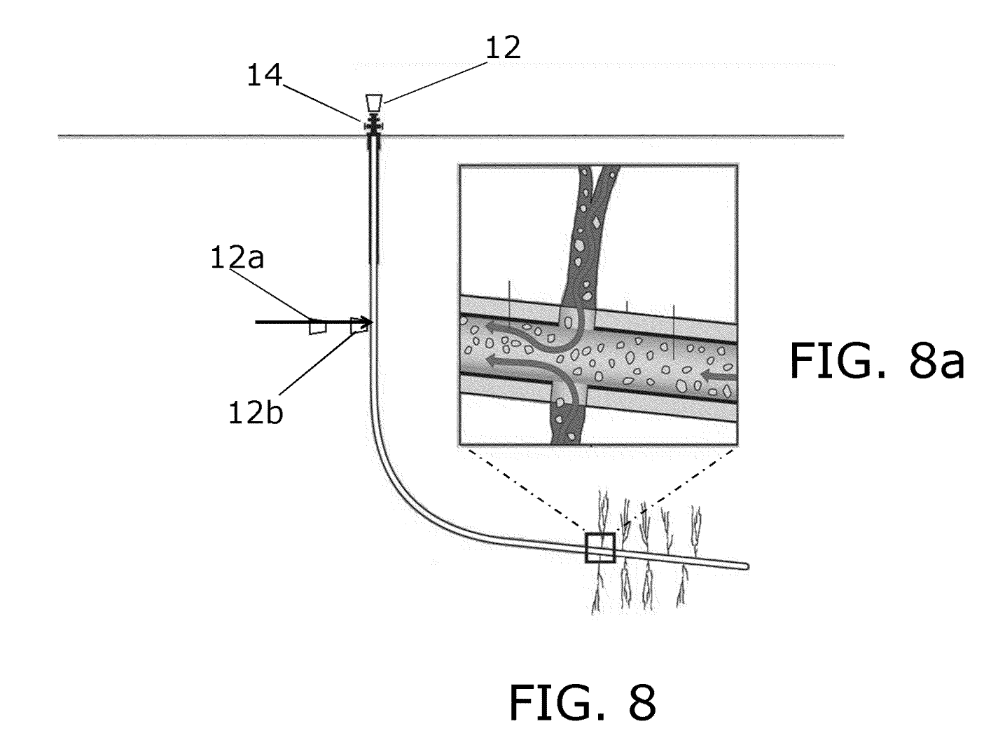

In at least one embodiment, as illustrated in FIG. 8, one or more apparatuses (12) for feeding chemicals into a hydrocarbon process stream are positioned in one or more of a number of locations. These include proximate to a well head (14) of a well bore. This orientation reduces the possibility of deactivation of the chemicals added to the process stream and unnecessary time delays, which hence reduces the amount of chemicals needed, and provides better control of both the chemicals added to the process stream and final end product properties.

Also shown in FIG. 8, in at least one embodiment at least two pre-mixing devices (12a, 12b) are serially positioned. One or more of these mixing devices can be the same type of feeding apparatus previously described (12 in FIG. 1) or they can be mechanical mixers or any other mixing device known in the art. In at least one embodiment one or more a chemical additives or one or more emulsifiers are added to a feeding fluid which enters into a first mixing device (12a) and the resulting first mixture is then fed into a second mixing device (12b) which in turn.

In another embodiment, the mixing is a staged mixing-mixing of chemicals prior to their introduction into the process stream. Staged mixing lasts for a time period that comports with the desired reaction rate of the chemicals feed into the mixing apparatus. In yet a further embodiment, the staged mixing lasts from about 5 microseconds to about 500 milliseconds.

In another embodiment, the activity of said chemicals is controlled by adjusting the flow rate of said chemicals and said feeding liquid, which are introduced into said apparatuses. One or more pumps that are in communication with said apparatuses may adjust the flow rate of the chemicals and feeding liquid that are being introduced into the apparatus of the present invention. Staged mixing can be achieved in the mixing chamber by controlling flow rates of both the chemicals and the feeding liquid into the mixing chamber.

In another embodiment, the activity of said chemicals, prior to their introduction into said process stream, is controlled by adjusting the flow rate of said chemicals and said feeding liquid, which are introduced into said mixing chamber.

In another embodiment, the chemicals are diluted with a dilution liquid prior to their introduction in said first conduit (1) or said second conduit (4). In yet a further embodiment, the dilution liquid contains water.

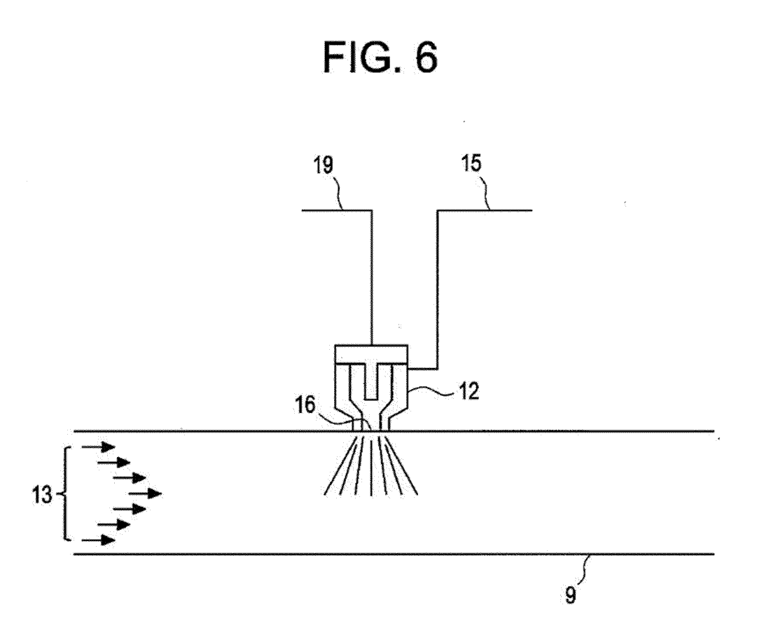

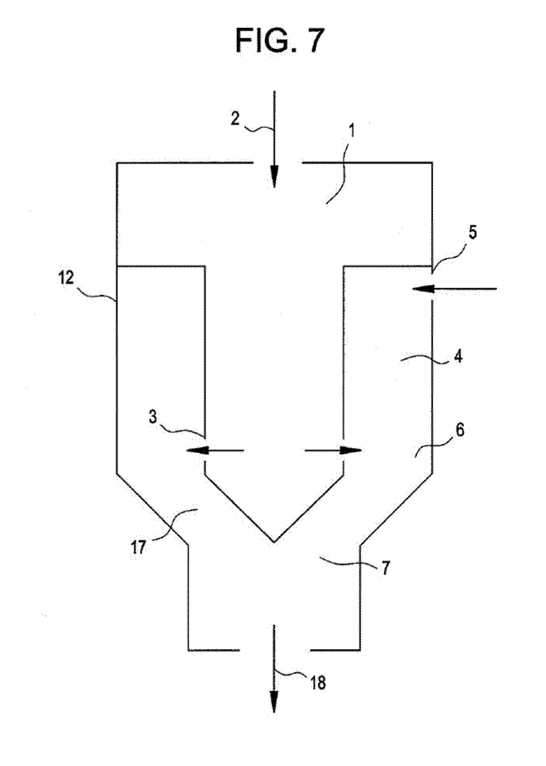

Referring to both FIGS. 6 and 7, in one embodiment, chemicals (19) are introduced into the inlet (2) of a first conduit (1). Subsequently the chemicals flow through the conduit and out said outlets (3) of the first conduit (1) and into the inlets (17) of the mixing chamber (7). A feeding liquid (15) is also introduced into a second conduit (4). The liquid in the second conduit (4) swirls or vortexes around the first conduit (1) and exits out the outlets (6) of the second conduit and into the mixing chamber (7) via the inlets (17) of the mixing chamber (7). The two fluids from the first conduit (1) and the second conduit (4) mix in the mixing chamber (7) and then the mixture flows through the mixing chamber (7) outlet (18), which in turn flows through the adaptor(S) that is mounted to an opening (16) in the process stream (13) and this liquid subsequently flows into the process stream (13).

While this invention may be embodied in many different forms, there described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and/or incorporated herein. In addition the invention encompasses any possible combination that also specifically excludes any one or some of the various embodiments described herein and/or incorporated herein.

The above disclosure is intended to be illustrative and not exhaustive. This description will suggest many variations and alternatives to one of ordinary skill in this art. The compositions and methods disclosed herein may comprise, consist of or consist essentially of the listed components, or steps. As used herein the term “comprising” means “including, but not limited to”. As used herein the term “consisting essentially of” refers to a composition or method that includes the disclosed components or steps, and any other components or steps that do not materially affect the novel and basic characteristics of the compositions or methods. For example, compositions that consist essentially of listed ingredients do not contain additional ingredients that would affect the properties of those compositions. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure. Weight percent, percent by weight, % by weight, wt %, and the like are synonyms that refer to the concentration of a substance as the weight of that substance divided by the weight of the composition and multiplied by 100.

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method of feeding a dispersion into a hydrocarbon process line comprising: essentially simultaneously manufacturing the dispersion and feeding the dispersion into a process line of a hydrocarbon process line.

2. The method of claim 1, wherein the dispersion is manufactured and essentially simultaneously fed to a hydrocarbon process line at a location that is a very close distance to the process pipe.

3. The method of claim 2, wherein the very close distance is a distance from 0 cm to about 2 cm.

4. The method of claim 1, wherein the dispersion is an emulsion.

5. The method of claim 1, wherein the dispersion is of a chemical additive to a fracking fluid.

6. The method of claim 5, wherein the chemical additive comprises a friction reducer fed at a speed such that but for the essentially simultaneous manufacturing and feeding, if it had not been pre-inverted, the friction reducer would not have had sufficient time to invert into a polymer in-oil emulsion before passing along casing walls of the hydrocarbon process line.

7. The method of claim 5, where in the chemical additive comprises a peracetic acid made in situ within the hydrocarbon process line and if it had been pre-generated rather than been made in situ, more of the acid would have degraded before contacting microorganisms and thereby been less effective.

8. The method of claim 5, where in the chemical additive is dispersed in the presence of a polymer flocculent selected from the group consisting of: latex polymers and dispersion polymers, an organic coagulant selected from the group consisting of an epichlorohydrin-dimethylamine condensation polymer and a polydiallyl-dimethylammonium chloride polymer, alone or in combination, with all inorganic coagulant, and a precipitant selected from the group consisting of an alkaline sodium aluminate liquor, an acidic magnesium salt in phosphoric acid/magnesium phosphate solution, and combinations thereof.

9. The method of claim 5, where in the chemical additive is selected from the list consisting of: hydrochloric acid, acetic acid, formic acid, 2,2-Dibromo-3-nitrilopropionamide, polycyclic organic matter, polynuclear aromatic hydrocarbons, gluteraldehyde, diammonium peroxidisulphate, ammonium persulfate, ammonium sulphate, ethylene glycol, glycol ethers, salts, tetramethyl ammonium chloride, potassium chloride, methanol, propargyl alcohol, boric acid, monoethanolamine, polyacylamide sodium acrylate-acylamide copolymer, guar gum, citric acid, thioglycolic acid, diesel, benzene, toluene, ethylbenzene, xylene, naphthalene, sand, ceramic beads, ammonium chloride, polyacrylate, methanol, isopropanol, and any combination thereof.

10. The method of claim 2 further comprising the steps of:
a) providing one or more feeding apparatuses, each feeding apparatus comprising:
a first conduit having one or more inlets and outlets;
a second conduit having one or more or more inlets and outlets, wherein the first conduit secures to the second conduit and traverses the second conduit;
a mixing chamber that has one or more inlets and outlets, wherein the second conduit secures to the mixing chamber and wherein the outlets of the first conduit and the outlets of the second conduit are in fluid communication with the mixing chamber; and
an adaptor that is in fluid communication with the outlet of the mixing chamber and is secured to the mixing chamber;
b) mounting at least one feeding apparatus containing an adaptor over an opening in the process pip,
c) introducing the dispersion and one or more chemicals into the mixing chamber of the feeding apparatus by introducing the dispersion or one or more chemicals into the inlets of the first conduit and the second conduit, the dispersion being introduced nearly simultaneous to its;
d) mixing the dispersion and one or more chemicals in the mixing chamber of the feeding apparatus to form a mixture; and
e) dispensing the mixture into the hydrocarbon process stream through the adaptor of the feeding apparatus that is in communication with the process stream.

11. The method of claim 2 in which the dispersion is introduced to the hydrocarbon process stream at a location along the stream consisting of: the well head, the well bore, the well casing, the production zone, the subterranean formation, and any combination thereof.
